(19) United States
(12) Patent Application Publication
(10) Pub. No.: US 2020/0174274 A1
(43) Pub. Date: Jun. 4, 2020

(54) DRIVING DEVICE, CAMERA DEVICE AND ELECTRONIC APPARATUS

(71) Applicant: New Shicoh Motor Co., LTD, Jiashan (CN)

(72) Inventors: Zaiwei Wang, Jiashan (CN); Juhe Zhou, Jiashan (CN)

(21) Appl. No.: 16/698,254

(22) Filed: Nov. 27, 2019

(30) Foreign Application Priority Data
Nov. 30, 2018 (CN) 201811453606.5
Nov. 30, 2018 (CN) 201811453741.X
Nov. 30, 2018 (CN) 201811453940.0
Nov. 30, 2018 (CN) 201811454454.0

(51) Int. Cl. G02B 27/64; H04N 5/232

(52) U.S. Cl. CPC G02B 27/646; G02B 7/10; H04N 5/23287

(57) ABSTRACT

A driving device includes a first driving unit and an anti-shake driving unit. The first driving unit includes a lens carrier for carrying a lens, a fixing frame body for movably supporting the lens carrier in an optical axis direction of the lens; and a first driving mechanism for driving the lens carrier in the optical axis direction of the lens. The anti-shake driving unit is disposed on a rear side in the optical axis direction of the lens of the first driving unit, includes a sensor carrier for carrying an image sensor and for allowing the image sensor to generate an image signal according to light transmitted by the lens, and further includes a second driving mechanism for driving the sensor carrier to move in a direction perpendicular to the optical axis direction of the lens according to the shake of the lens carrier.

### CROSS-REFERENCES TO RELATED APPLICATIONS

This application claims the benefit of Chinese patent applications CN201811453606.5, CN201811453741.X, CN201811453940.0 and CN201811454454.0, each filed on Nov. 30, 2018, the entire contents of which are incorporated herein by reference.

### TECHNICAL FIELD

The present disclosure relates to a driving device, a camera device using the driving device and an electronic apparatus using the camera device.

### BACKGROUND

A driving module is disclosed in a Chinese patent application of publication No. CN102089695A. The disclosed driving module has: a cylindrical or column-shaped driven body; a cylindrical support body that accommodates the driven body on the inner side; a leaf spring member elastically holding the driven body in such a manner that the driven body moves in a certain direction with respect to the support body; and a driving unit resisting the restoring force of the leaf spring member to drive the driven body along a certain direction. The drive module is characterized in that the driving unit has: a shape memory alloy wire that is engaged with the driven body and that drives the driven body by the contraction caused by heat generation during energization, resisting the restoring force of the leaf spring member; and a holding terminal holding an alloy wire holding portion at an end portion of the shape memory alloy wire. The holding terminal has a fitting portion that is fitted to the support body and is positioned, and a restricting portion that prevents rotation with respect to the support body, and the holding terminal is supported and fixed to the support body.

After the driving module is zoomed, the time required for the lens to stably move to the predetermined position is expected to be further shortened.

Further, a driving device is disclosed in a Chinese patent application of application No. 201721565529.3. It is driven by SMA (Shape Memory Alloy) and AF (autofocus) is driven by anti-shake VCM (voice coil motor). An outer casing and SMA base are added to the original AF driver, and the outer casing is fitted in the SMA base. The SMA base realizes the anti-shake effect by controlling the AF structure (a connecting portion may be provided between the SMA base and the AF structure) to realize the movement of the AF structure on the X and Y axes.

Since an outer casing is to be added, the size of the driving device is increased, which is disadvantageous for miniaturization of the product.

### SUMMARY

A first object of the present disclosure is to provide a driving device, a camera device and an electronic apparatus which are provided with an anti-shake function and are capable of shortening the driving time.

Further, a second object of the present disclosure is to provide a driving device, a camera device and an electronic apparatus which have an effect of miniaturizing a product.

According to a first aspect of the present disclosure, there is provided a driving device including a first driving unit and an anti-shake driving unit. The first driving unit includes a lens carrier for carrying a lens; and a first driving mechanism which drives the lens carrier in the optical axis direction of the lens.

The anti-shake driving unit is disposed on a rear side in the optical axis direction of the lens of the first driving unit, and includes a sensor carrier for carrying an image sensor and allowing the image sensor to generate an image signal according to light transmitted through the lens; and further includes a second driving mechanism for driving the sensor carrier to move in a direction perpendicular to the optical axis direction of the lens according to the shake of the lens carrier in order to compensate for the shake.

According to a second aspect of the present disclosure, a driving device is provided. The driving device includes a first driving unit including a lens and a first driving mechanism for driving the lens in an optical axis direction of the lens.

The driving device further includes an anti-shake driving unit and a base. The anti-shake driving unit includes a sensor carrier for carrying the image sensor, and a second driving mechanism for driving the sensor carrier in a direction perpendicular to the optical axis direction. The base is provided with the first driving unit on a front side in an optical axis direction thereof and the anti-shake driving unit on a rear side in the optical axis direction thereof. The sensor carrier is disposed on a rearmost side in an optical axis direction of the anti-shake driving unit, and a carrying surface is provided as a connecting position for mounting the image sensor.

According to a third aspect of the present disclosure, a driving device is provided. The driving device includes a first driving unit including a lens and a first driving mechanism for driving the lens in an optical axis direction of the lens.

The driving device further includes an anti-shake driving unit and a base. The anti-shake driving unit includes: an image sensor for generating an image signal according to light transmitted through the lens; a sensor carrier for carrying the image sensor; a second driving mechanism for driving the sensor carrier in a direction perpendicular to the optical axis direction; and a data connector being a flexible member and extending in a strip shape for connecting the image sensor and an external circuit to transmit an image signal. The base is provided with the first driving unit on a front side in an optical axis direction thereof and the anti-shake driving unit on a rear side in the optical axis direction thereof.

According to a fourth aspect of the present disclosure, a driving device is provided. The driving device includes a first driving unit including: a lens carrier for carrying a lens; and a first driving mechanism for driving the lens carrier in an optical axis direction of the lens. The driving device further includes a base and an anti-shake driving unit. The base includes a supporting substrate, an enclosure sidewall is extending from the supporting substrate along a direction parallel to the optical axis on a rear side in the optical axis direction of the supporting substrate, and a cavity portion is defined by the enclosure sidewall and the supporting substrate. The anti-shake driving unit is accommodated in the cavity portion and the first driving unit is fixed on a front side in the optical axis direction of the supporting substrate. The anti-shake driving unit includes: a sensor carrier for carrying an image sensor and allowing the image sensor to generate an image signal according to light transmitted through the lens; and a second driving mechanism for driving the sensor carrier to move in a direction perpendicular to the optical axis direction according to the shake of the lens carrier in order to compensate for the shake.

According to a fifth aspect of the present disclosure, there is provided a camera device comprising a lens, an image sensor, and a driving device mentioned above for driving the lens to generate image data on the image sensor.

According to a sixth aspect of the present disclosure, there is provided an electronic apparatus comprising the above-mentioned camera device.

The lens is adjusted by the first driving unit along the optical axis direction of the lens to perform autofocusing, and the position of the image sensor is adjusted by the anti-shake driving unit in a plane perpendicular to the optical axis direction to compensate for the shake. The auto-focus and the motion of compensating the shake are independent from each other, that is, the auto-focus does not receive the effect of the motion of compensating the shake, so the lens can be quickly stabilized, the shooting quality is improved, and the user's sense of use is improved.

### DESCRIPTION OF THE DRAWINGS

The above and other features, properties and advantages of the present disclosure will become more apparent from the following description in conjunction with the accompanying drawings and Examples:

FIG. 1 is a perspective view of a first embodiment of a driving device;

FIG. 2 is an exploded view of the first embodiment of the driving device;

FIG. 3A is a perspective view of a base;

FIG. 3B is a perspective view of another viewpoint of the base;

FIG. 4A is a perspective view of a second driving mechanism;

FIG. 4B is a perspective view of another viewpoint of the second driving mechanism;

FIG. 5 is an exploded view of the second driving mechanism;

FIG. 6A is a perspective view of a sensor carrier;

FIG. 6B is a perspective view of another viewpoint of the sensor carrier;

FIG. 7A is a perspective view of a data connector;

FIG. 7B is a plan view of the data connector mated with the image sensor;

FIG. 8 is a front view of the first embodiment of the driving device;

FIG. 9 is a cross-sectional view taken along line B-B of FIG. 8; and

FIG. 10 is an exploded view of the second embodiment of the driving device.

### DETAILED DESCRIPTION

Various embodiments for implementing the subject technical solutions are hereinafter disclosed. The specific examples of the components and the arrangements are described below only for the purpose of simplifying the disclosure, and of course, these are merely examples, and are not intended to limit the protection scope of the present disclosure. For example, a first feature described later in the specification is formed over or on the second feature, and may include an embodiment in which the first and second features are formed by direct contact, and may also include an embodiment in which an additional feature is formed between the first feature and the second feature, so that the first feature and second feature may not be directly related. Additionally, reference numerals and/or letters may be repeated in different examples in these disclosures. This repetition is for the sake of brevity and clarity, and does not by itself represent the relationship between the various embodiments and/or structures to be discussed. Further, when a first element is described to be connected to or combined with a second element, the description includes embodiments in which the first and second elements are directly connected or combined with each other, and also includes the use of one or more other intervening elements to indirectly connect or join the first and second elements to each other.

In order to facilitate the understanding, in the embodiment to be described later, the optical axis direction of the lens 12 is referred to as a Z direction, the direction perpendicular to the optical axis direction is referred to as an X direction, and the direction perpendicular to the Z direction and the X direction is referred to as a Y direction. Further, the object side of the optical axis is referred to as a front side, and the opposite side or the side on which an image sensor (not shown) is disposed is referred to as a rear side.

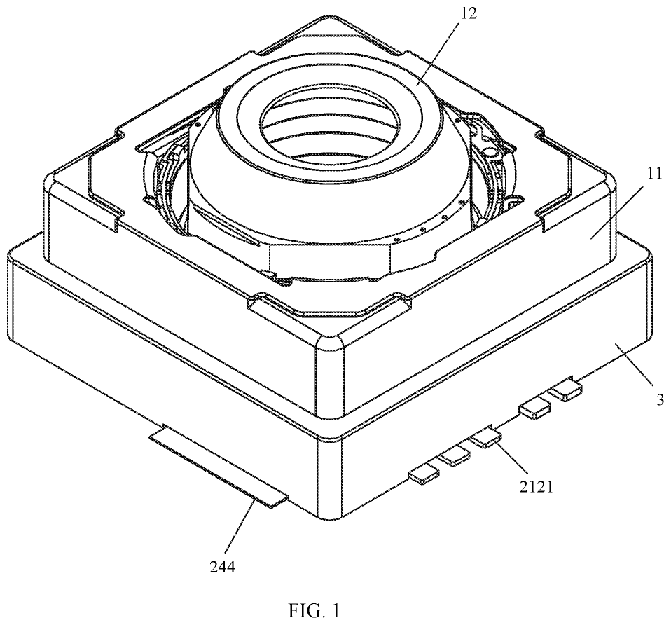

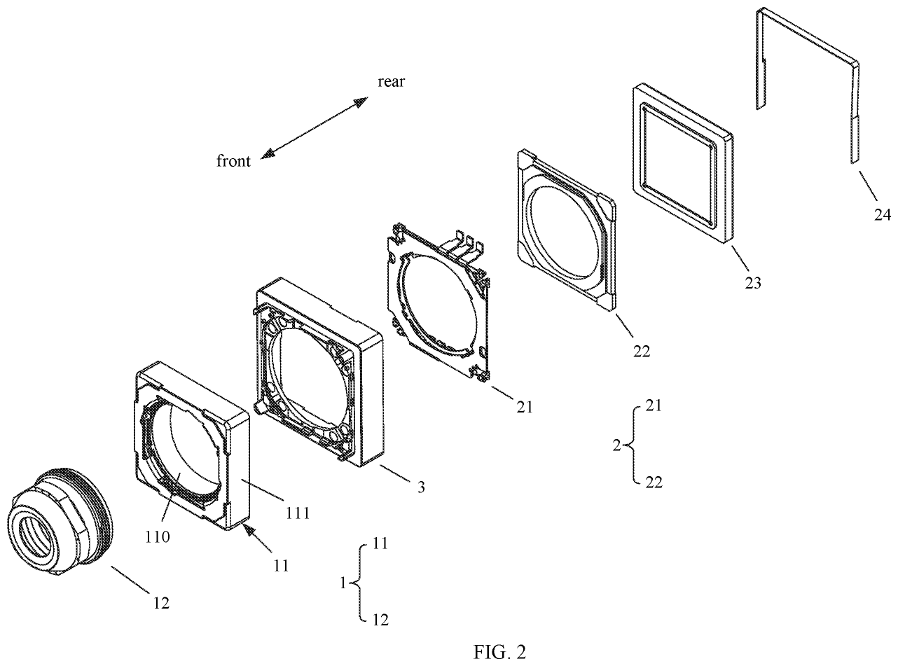

First, the first embodiment will be described. The driving device as shown in FIG. 1 and FIG. 2 includes a first driving unit 1 and a second driving unit 2, and further includes a base 3.

The first driving unit 1 includes a linear driving device 11. In the following embodiments, the lens 12 may also be considered as a composition of the first driving unit 1. The second driving unit 2 is also referred to as an anti-shake driving unit.

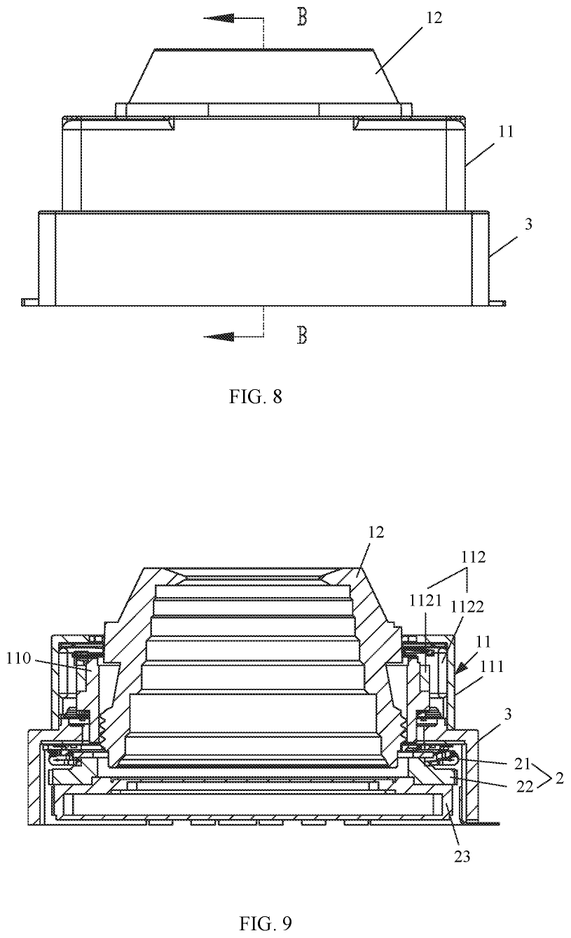

As the configuration of the linear driving device 11, reference may be made to the lens driving device disclosed in a Chinese patent publication CN104765125A. The linear driving device 11 generally includes a lens carrier 110, a fixing frame body 111 and a first driving mechanism 112 (see FIG. 9). The fixing frame body 111 is referred to as an outer casing or a magnetic yoke, and constitutes a fixed body together with a base 3 to be described later, and the lens carrier 110 is movably supported by an elastic element in the optical axis direction of the lens. Referring to FIG. 8 and FIG. 9, the first driving mechanism 112 includes a magnet 1122 and a coil 1121. The magnet 1122 is disposed on a fixing frame body 111, and the coil 1121 is disposed on the lens carrier 110, and the positions of the magnet 1122 and the coil 1121 are also interchangeable. When magnetizing current is passed through the coil 1121, an interaction force is generated between the coil 1121 and the magnet 1122 to push and move the lens carrier 110 so that the lens carrier 110 is moved in the optical axis direction of the lens 12.

The configuration of the linear driving device 11 is not limited thereto, and a linear driving device disclosed in a Chinese patent publication CN101860258A or CN102062927A by the applicant “Shicoh Motor (Shanghai) Co., Ltd” may be adopted.

As described above, the base 3 not only functions to support the first driving unit 1, but also functions to support the second driving unit 2.

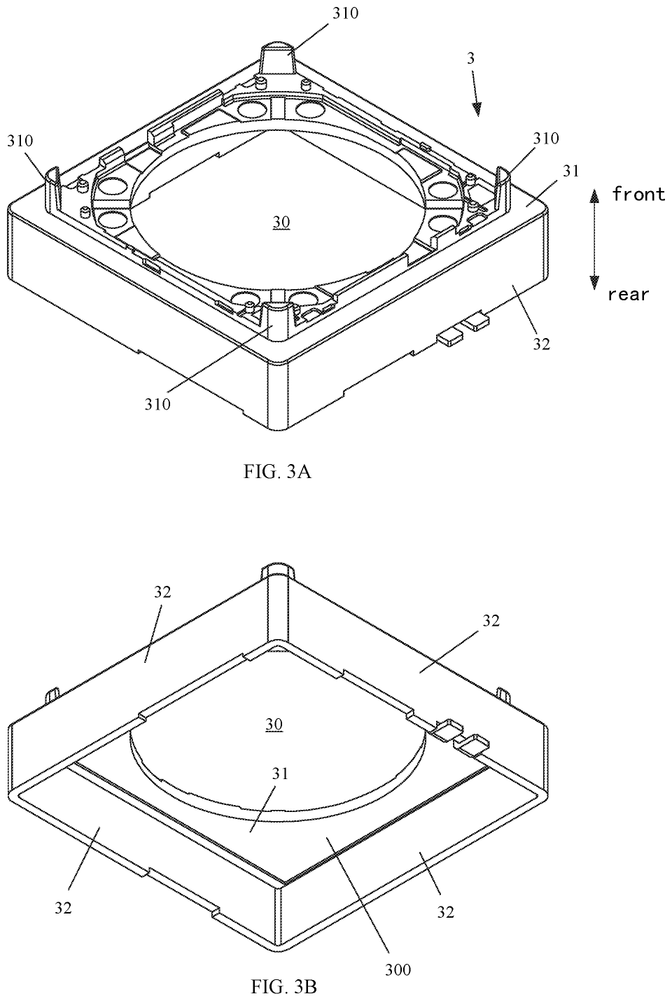

As shown in FIG. 3A and FIG. 3B, the base 3 includes a supporting substrate 31, an enclosure sidewall 32 is extending along a direction parallel to the optical axis toward a rear side in the optical axis direction of the supporting substrate 31, and a cavity portion 300 is defined by the enclosure sidewall 32 and the supporting substrate 31. As shown in FIG. 9, the second driving unit 2 is accommodated in the cavity portion 300, that is, as shown in FIG. 2, the first driving unit 1 is fixed on the front side of the base 3, and the second driving unit 2 is fixed on the rear side of the base 3. That is, the first driving unit 1 and the second driving unit 2 are connected and fixed to each other via the base 3

The supporting substrate 31 is substantially square in shape and provided with a hole 30 for transmitting light transmitted through the lens 12. The supporting substrate 31 is provided with four convex columns 310 at four corner portions on the front side thereof. The supporting substrate 31 has four convex columns 310 arranged at four corners on the front side thereof, and the outer peripheral side surfaces of the convex columns 310 face the outer side of the supporting substrate 31 and is fitted with the corner portion of the fixing frame body 111, and the fixing frame body 111 is fixed to the supporting substrate 31 by adhering or the like.

The second driving unit 2 includes a second driving mechanism 21 and a sensor carrier 22. In one embodiment of the second driving mechanism 21, a SMA driver is employed, which performs driving by using SMA (shape memory alloy) material. The sensor carrier 22 is used to carry an image sensor 23 and allows the image sensor to generate an image signal according to light transmitted through the lens. The second driving mechanism 21 drives the sensor carrier 23 to move in a direction perpendicular to the optical axis direction of the lens 12 according to shake of the lens carrier 110 in order to compensate for the shake.

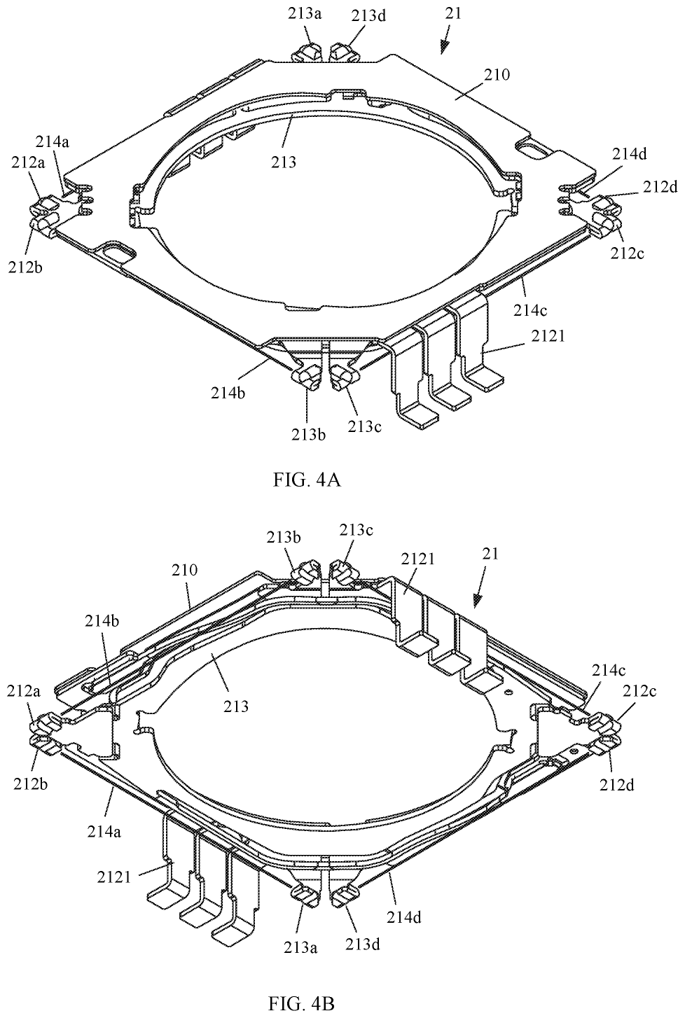

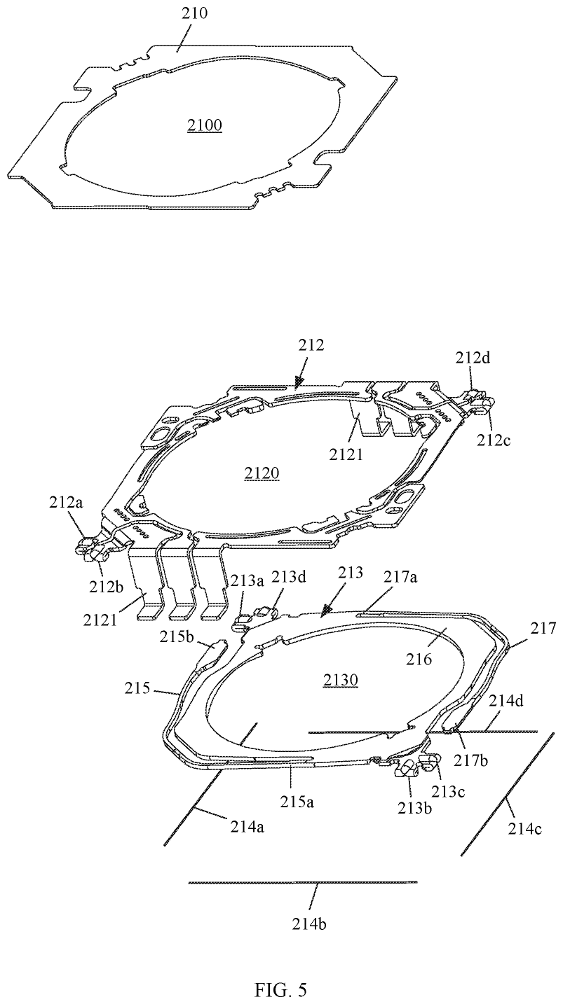

The second driving mechanism 21 is shown in FIG. 4A, FIG. 4B and FIG. 5 and includes four SMA wires 214a, 214b, 214c and 214d. The SMA wire can be stretched or shortened according to the input driving current.

The second driving mechanism 21 further includes a movable plate 213 and a fixed plate. The fixed plate includes a fixing portion 212 and a bottom plate 210. The movable plate 213 is provided to become a motion output portion of the second driving mechanism 21 and is connected to the sensor carrier 22. The movable plate 213 has a square plate body 216. Wire fixing portions 213a and 213d are provided at one corner of one pair of opposite corner portions of the square plate body 216, and wire fixing portions 213b and 213c are provided at the other corner. Flexible arms 215 and 217 respectively extend from the middle portions of two opposite edges of the square plate body 216. The flexible arms 215 and 217 extend along the same rotational direction substantially in accordance with the outer peripheral shapes of the square plate body 216, bend by 90 degrees at their starting edges, turn around the corners of the other pair of opposite corner portions of the square plate body 216 and then stop before extending up to the corners of the one pair of opposite corner portions. In other words, the flexible arm 215 has a starting end 215a and an end edge 215b, and the starting end 215a is connected to the middle of one edge of the square plate body 216. The flexible arm 217 has a starting end 217a and an end edge 217b, and the starting end 217a is connected to the middle of one edge of the square plate body 216 that is opposite to the starting end 215a.

The fixing portion 212 is substantially square in shape, wire fixing portions 212a and 212b are provided at one corner of the opposite corner portions, and wire fixing portions 212c and 212d are provided at the other corner, and terminals 2121 extend to two opposite edges. The fixing portion 212 is fixed to the rear side of the bottom plate 210. The bottom plate 210 is also substantially square in shape. As shown in FIG. 5, the bottom plate 210, the fixing portion 212 and the movable plate 213 are sequentially disposed adjacent to each other in such a manner that the four sides of the respective elements are substantially aligned. The two corner portions of the fixing portion 212 provided with the wire fixing portions 212a, 212b, 212c and 212d and the two corner portions of the movable plate 213 provided with the wire fixing portions 213a, 213b, 213c and 213d are respectively distributed at the ends of the intersecting diagonal lines. One end of the SMA wire 214a is fixed to the wire fixing portion 212a, and the other end is fixed to the wire fixing portion 213a. One end of the SMA wire 214b is fixed to the wire fixing portion 212b, and the other end is fixed to the wire fixing portion 213b. One end of the SMA wire 214c is fixed to the wire fixing portion 212c, and the other end is fixed to the wire fixing portion 213c. One end of the SMA wire 214d is fixed to the wire fixing portion 212d, and the other end is fixed to the wire fixing portion 213d.

The driving current is made to flow from the terminal 2121 of the fixing portion 212, and at least a part of the SMA wires therein is contracted or stretched. When one of the SMA wires on two parallel opposite sides is contracted and the other one is stretched, the movable plate 213 is driven to move together with the sensor carrier 22 in a direction perpendicular to the optical axis direction. On the other hand, when the SMA wires on these two sides perform only one of contraction and stretching only, the movable plate 213 is driven to rotate together with the sensor carrier 22. Therefore, a controller (not shown) calculates a desired compensation motion based on the position signal of the lens carrier, and then inputs a corresponding driving current to different SMA wires, which realizes shake compensation. The specific control method can refer to the existing shake compensation control algorithm. For example, in the Chinese patent document CN102262280A previously published by the applicant, the motion perpendicular to the optical axis direction (anti-shake correction) receives the anti-shake correction amount in the X direction and the Y direction perpendicular to the optical axis direction (Z direction) according to the gyro component or the like as a signal, and calculates the anti-shake correction amount in the X direction and the Y direction to determine the amount of movement of the sensor carrier, and then power is supplied to some or all of the SMA wires.

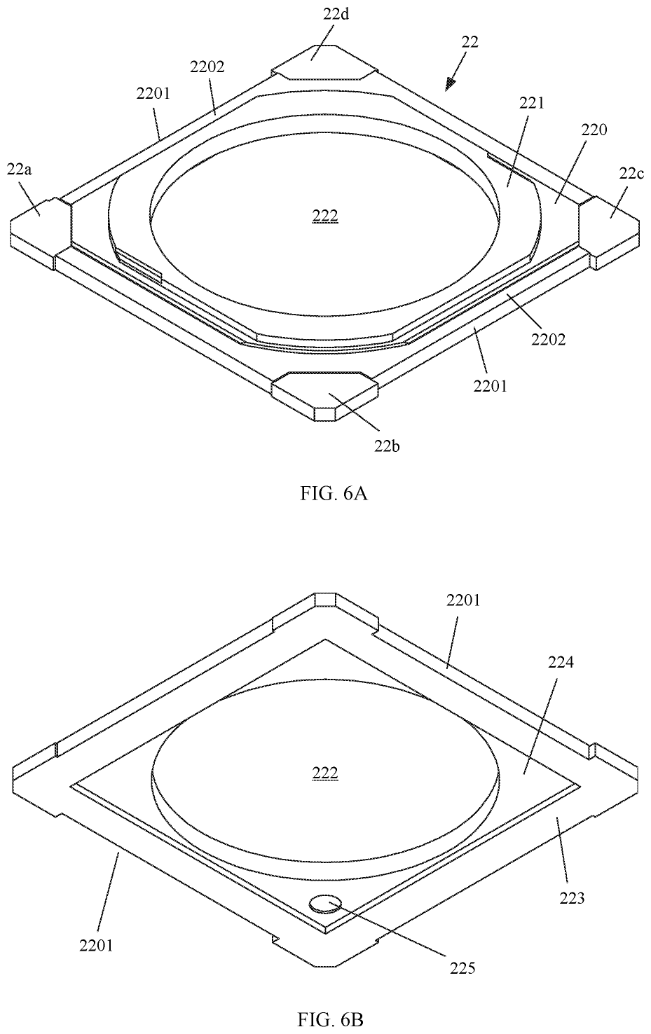

The front side surface of the bottom plate 210 is fixedly connected to the rear side surface of the supporting substrate 31 of the base 3 by adhering or the like. The hole 30 of the supporting substrate 31, the hole 2100 of the bottom plate 210, the hole 2120 of the fixing portion 212, the hole 2130 of the movable plate 213, and the driving current is made to flow from the terminal 2121 of the fixing portion 212, and at least a part of the SMA wires therein is contracted or stretched. When one of the SMA wires on two parallel opposite sides is contracted and the other one is stretched, the movable plate 213 is driven to move together with the sensor carrier 22 in a direction perpendicular to the optical axis direction. On the other hand, when the SMA wires on these two sides are contracted or stretched only, the movable plate 213 is driven to rotate together with the sensor carrier 22. The hole 222 of the sensor carrier 22 as shown in FIG. 6A and FIG. 6B are arranged on the same axis line to allow all of the light transmitted through the lens 12 to pass therethrough and irradiate the image sensor 23.

As shown in FIG. 6A and FIG. 6B, the sensor carrier 22 has a substantially square plate body including a front side surface 220 and a carrier front adhesion surface 221 protruding from the front side surface 220, and stopping recesses 22a, 22b, 22c and 22d are formed at four corner portions of the front side surface 220, respectively. The sensor carrier 22 also includes a hole 222. The hole 222 extends through the sensor carrier 22 from the carrier front adhesion surface 221 to the rear side to allow light pass therethrough. Notches 2201 are further formed on the opposite two edges of the sensor carrier 22, and the notches 2201 are provided as avoiding portions of the terminals 2121. Wire-avoiding portions 2202 are further formed on four side edges of the front side surface 220 by thinning the thickness, respectively. The wire-avoiding portions 2202 facilitate the provision of four SMA wires 214a, 214b, 214c and 214d and provide an activity space for the four SMA wires 214a, 214b, 214c and 214d. The rear side surface of the sensor carrier 22 is a carrying surface for carrying the image sensor 23. The carrying surface includes a first adhesion surface 223 formed on four edges thereof, and a second adhesion surface 224 recessed from the first adhesion surface 223 toward the front side. In one example, the second adhesion surface 224 is a recessed bottom surface with a square counter-bored recess formed by applying such as counter sinking process to the first adhesion surface 223. The image sensor 23 is adhered on the first adhesion surface 223 and the second adhesion surface 224, respectively. A positioning hole 225 is further provided at one corner portion of the second adhesion surface 224.

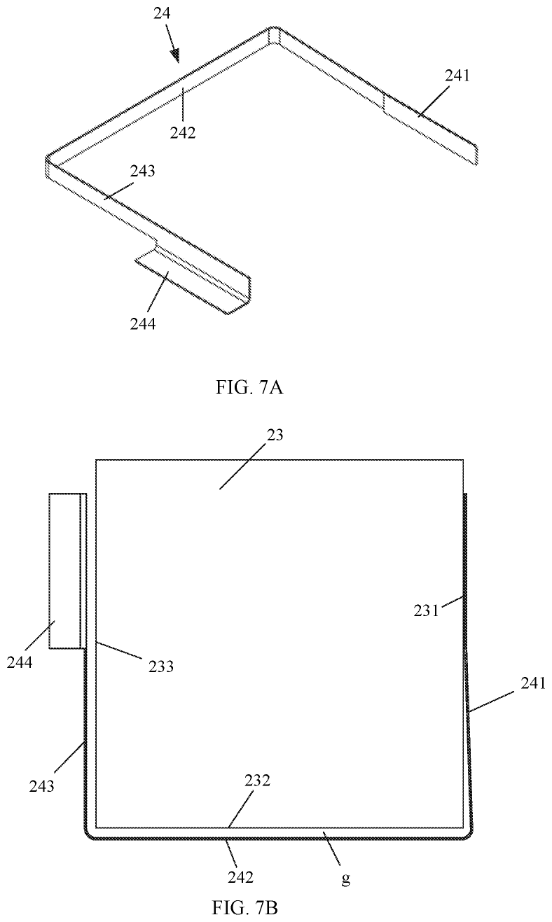

As shown in FIG. 1, FIG. 2, FIG. 7A and FIG. 7B, the image sensor 23 is connected to an external circuit (not shown) through the data connector 24. The data connector 24 is a flexible member in which a signal line is arranged within a thin plastic sheet, and includes a first extending portion 241, a second extending portion 242 and a third extending portion 243. The second extending portion 242 is connected to the first extending portion 241 and the third extending portion 243. The second extending portion 242 is separated from the second edge 232 of the image sensor 23 in parallel, and the third extending portion 243 is separated from the third edge 233 of the image sensor 23 in parallel. The end of the first extending portion 241 is connected to the first edge 231 of the image sensor 23, and is separated from the first edge 231 so as to gradually expand toward the connecting end with the second extending portion 242. An external circuit connecting portion 244 is arranged toward the side away from the third edge 233 of the third extending portion 243. The gap g between each of the extending portions 241, 242, 243 and the image sensor 23 provides an activity space for the image sensor 23, specifically, a space for movement or rotation in a plane perpendicular to the optical axis direction.

In the above first embodiment, the lens 12 is adjusted by the first driving unit along the optical axis direction of the lens to perform autofocusing, and the position of the image sensor 23 is adjusted by the second driving unit driven by the SMA wires in a plane perpendicular to the optical axis direction, thereby, the shake is compensated. The auto-focus and the motion of compensating the shake are independent from each other, thus, the auto-focus does not receive the effect of the motion of compensating the shake, or the motion of compensating the shake is not affected by the auto-focus motion but only moves according to the shake, so that the lens 12 can be quickly stabilized, the imaging quality can be improved, and the user's sense of use can be improved.

Also, in the first embodiment, the first driving unit and the second driving unit share the same base, without additionally adding an outer casing and a bottom plate. The length and width and the overall size thereof can thus be made smaller. When it is applied to electronic apparatus such as mobile phones or the like, the electronic apparatus is allowed to be made thinner. Therefore, the previous embodiment can achieve the effect of miniaturization.

Furthermore, in the first embodiment, the sensor carrier is located on the rearmost side of the second driving unit, specifically, the sensor carrier 22 is on the rearmost side of the cavity portion 300 of the base 3, and an opening of the cavity portion 300 is defined by the rear side of the enclosure sidewall 32. The opening exposes the sensor carrier 22, that is, the first adhesion surface 223 and the second adhesion surface 224 that are carrying surfaces of the sensor carrier 22 are provided as connection sites of the image sensor, and high flexibility can be obtained by the arrangement of the image sensor. In other words, various implementation bodies can be provided with various image sensors according to the specific settings of the products, so that the usage scene of the driving device can be expanded and the market value of the driving device can be further increased.

Also, in the first embodiment, the data connector 24 is disposed around the three edges of the image sensor 23 and provides an activity space for the image sensor 23, and further connects the image sensor 23 and an external circuit (not shown). Such arrangement allows the image sensor 23 to be driven by the second driving unit 2 to move in a vertical plane perpendicular to the optical axis direction. And the length from the connecting position of the first extending portion 241 of the data connector 24 and the image sensor 23 to the external circuit connecting portion 244 of the third extending portion 243 of the data connector 24 is provided with an allowance. This allowance allows the data connector 24 to be deformed, such as torsion, twist, etc., and avoids generating an excessive torsional force that breaks the connection of the data connector 241 and the image sensor 23 at the connecting position, thereby improving the quality of the product.

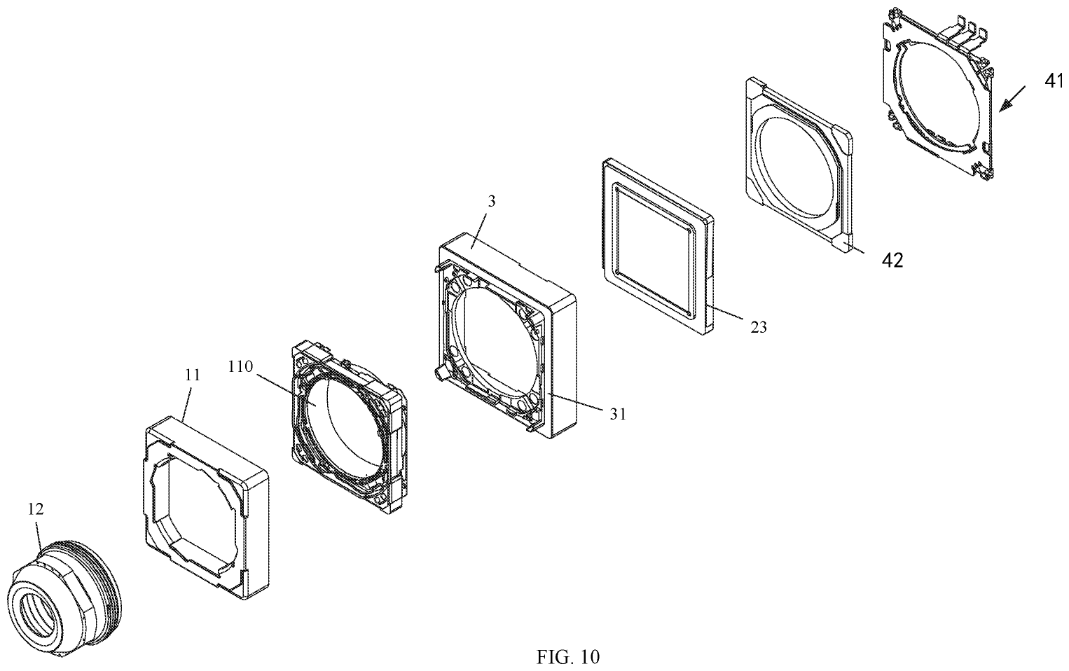

FIG. 10 shows a second embodiment of the driving device, which differs from the first embodiment in that the image sensor 23 is disposed on the front side of the sensor carrier 42 and the second driving device 41 is disposed on the rear side of the sensor carrier 42. The sensor carrier 42 is thus disposed on the front side of the second driving device 41, locating between the supporting substrate 31 of the base 3 and the second driving device 41. The second driving mechanism 41 may adopt the structure shown in FIG. 4A, FIG. 4B, and FIG. 5, but in the adopted configuration the front and rear sides are reversed. That is, the movable plate is located on the front side of the second driving mechanism 41, the fixing portion is located in the middle, and the bottom plate is located on the rear side of the second driving mechanism 41. The bottom plate of the second driving device 41 is fixed in contact with the enclosure sidewall 32 of the base 3. The rear side of the sensor carrier 42 is connected to the movable plate of the second drive mechanism 41, and the image sensor 23 is correspondingly disposed on the front side of the sensor carrier 42. The sensor carrier 42 shown in FIG. 10 can adopt substantially the same structure as the sensor carrier 22 shown in FIG. 6A and FIG. 6B, but the front and rear sides thereof are opposite to those of the sensor carrier 22. The second driving mechanism 41 shown in FIG. 10 can also adopt substantially the same structure as the second driving mechanism 21 shown in FIG. 4A, FIG. 4B and FIG. 5, but the front side and the rear side thereof are opposite to those of the second driving mechanism 21. Specifically, for the second driving mechanism 41 the movable plate is located on the front side thereof and the bottom plate is located on the rear side thereof.

The present disclosure is disclosed in the above preferred embodiments, but is not intended to limit the present disclosure, and any changes and modifications may be made by those skilled in the art without departing from the spirit and scope of the present disclosure. For example, in another embodiment, the sensor carrier is omitted or integral with the movable plate of the second driving mechanism and the image sensor is directly combined with the movable plate. For another example, as yet another embodiment, the fixed plate of the second driving mechanism and the supporting substrate of the base are integrally provided.

Therefore, any alternations, equivalent changes, and modifications made to the above examples in accordance with the technical essence of the present disclosure without departing from the technical solution of the present disclosure shall fall within the scope of protection defined by the claims of the present disclosure.

What is claimed is:

1. A driving device, comprising:
a first driving unit comprising:
a lens carrier for carrying a lens; and
a first driving mechanism for driving the lens carrier in the optical axis direction of the lens;
wherein,
the driving device further comprises an anti-shake driving unit, and the anti-shake driving unit is disposed on a rear side of the optical axis direction of the first driving unit and comprises:
a sensor carrier for carrying an image sensor and allowing the image sensor to generate an image signal according to light transmitted through the lens; and
a second driving mechanism for driving the sensor carrier to move in a direction perpendicular to the optical axis direction of the lens according to the shake of the lens carrier in order to compensate for the shake.

2. The driving device according to claim 1, wherein
the second driving mechanism comprises a plurality of SMA wires, a movable plate and a fixed plate,
the SMA wires connect the movable plate and the fixed plate, changes the lengths thereof according to an input driving current to drive the movable plate to move relative to the fixed plate, and
the sensor carrier is configured to move in accompany with the movable plate.

3. The driving device according to claim 2, wherein the sensor carrier and the movable plate are integrally connected to each other or connected as two separate members.

4. The driving device according to claim 2, wherein the fixed plate is connected to the first driving unit.

5. The driving device according to claim 2, wherein the sensor carrier and the movable plate are disposed on a front side of the anti-shake driving unit along the optical axis direction of the lens.

6. The driving device according to claim 2, wherein the sensor carrier and the movable plate are disposed on a rear side of the anti-shake driving unit along the optical axis direction of the lens.

7. The driving device according to claim 1, wherein the first driving mechanism includes a coil and a magnet, the coil generates an Ampere force between the coil and the magnet according to an input driving current, thereby driving the lens carrier.

8. The driving device according to claim 1, comprising:
a base provided with the first driving unit on a front side in the optical axis direction and the anti-shake driving unit on a rear side in the optical axis direction,
wherein the sensor carrier is disposed on a rearmost side in an optical axis direction of the anti-shake driving unit, and a carrying surface serving as a connecting position for mounting the image sensor is provided.

9. The driving device according to claim 8, wherein the carrying surface comprises:
a first adhesion surface; and
a second adhesion surface recessed from the first adhesion surface to a front side in an optical axis direction of the sensor carrier.

10. The driving device according to claim 9, wherein the first adhesion surface has a square shape, and the second adhesion surface is a recess bottom surface with a square counter-bored recess formed from the first adhesion surface.

11. The driving device according to claim 9, wherein at least one corner portion of the second adhesion surface is provided with a positioning hole.

12. The driving device according to claim 8, wherein
the second driving mechanism comprises a plurality of SMA wires, a movable plate and a fixed plate,
the SMA wires connect the movable plate and the fixed plate and change in length according to an input driving current to drive the movable plate to move relative to the fixed plate, and
the sensor carrier is configured to accompany the movement of the movable plate.

13. The driving device according to claim 12, wherein,
the sensor carrier includes a carrier front adhesion surface on a front side in an optical axis direction thereof, and a plurality of stopping recesses spaced apart around the carrier front adhesion surface,
the movable plate includes a movable plate adhesion surface on a rear side in an optical axis direction, and
the carrier front adhesion surface is adhesive to the movable plate adhesion surface.

14. The driving device according to claim 13, wherein the carrier front adhesion surface protrudes from a front side surface on the front side of the sensor carrier in the optical axis direction thereof, and the stopping recess has a shape recessed in the optical axis direction with respect to the front side surface.

15. The driving device according to claim 1,
a first driving unit that comprises;
a lens and
a first driving mechanism for driving the lens in an optical axis direction of the lens;
wherein
the driving device further comprises a base provided with the first driving unit on a front side in the optical axis direction and the anti-shake driving unit on a rear side in the optical axis direction,
the anti-shake driving unit that comprises;
an image sensor for generating an image signal according to light transmitted through the lens,
a sensor carrier for carrying the image sensor,
a second driving mechanism for driving the sensor carrier in a direction perpendicular to the optical axis direction, and
a data connector for connecting the image sensor and an external circuit to transmit the image signal,
the data connector being a flexible member and extending in a strip shape for connecting the image sensor and an external circuit to transmit an image signal.

16. The driving device according to claim 15, wherein the image sensor is square in shape, the data connector includes a first extending portion, a second extending portion and a third extending portion, and the second extending portion is connected to the first extending portion and the third extending portion,
an end edge of the first extending portion is connected to a first edge of the image sensor, and is separated from the first edge in a diverging manner toward a connecting end of the second extending portion,
the second extending portion is parallel to and separated from a second edge of the image sensor, and the third extending portion is parallel to and separated from a third edge of the image sensor,
an external circuit connecting portion is provided on a side of the third extending portion facing away from the third edge,
a gap between the data connector and the image sensor provides an activity space for the image sensor.

17. The driving device according to claim 15, wherein
the second driving mechanism comprises a plurality of SMA wires, a movable plate and a fixed plate,
the SMA wires connect the movable plate and the fixed plate and change in length according to an input driving signal to drive the movable plate to move relative to the fixed plate,
the sensor carrier is configured to move in accompany with the movable plate.

18. The driving device according to claim 17, wherein,
the sensor carrier is disposed on a rearmost side in the optical axis direction of the second driving mechanism, and the image sensor is connected to a rear side surface in optical axis direction of the sensor carrier.

19. The driving device according to claim 15, wherein the base includes a supporting substrate, an enclosure sidewall is extending along a direction parallel to the optical axis on a rear side in the optical axis direction of the supporting substrate, a cavity portion is defined by the enclosure sidewall, and accommodating the anti-shake driving unit therein.

20. The driving device according to claim 1,
Further comprising a base comprising a supporting substrate,
the base further comprises an enclosure sidewall extending in parallel with the optical axis direction on a rear side in the optical axis direction of the supporting substrate, and a cavity portion is surrounded by the enclosure sidewall and the supporting substrate,
the anti-shake driving unit is accommodated in the cavity portion and the first driving unit is fixed on a front side in the optical axis direction of the supporting substrate.

21. The driving device according to claim 20, wherein the first driving unit further comprises a fixing frame body fixed on a surface of the front side of the supporting substrate, and the lens carrier is driven so as to move in the optical axis direction in the fixing frame body.

22. The driving device according to claim 20, wherein the first driving mechanism includes a coil and a magnet, the coil generates an Ampere force between the coil and the magnet according to an input driving current, thereby driving the lens carrier.

23. The driving device according to claim 20, wherein
the second driving mechanism comprises a plurality of SMA wires, a movable plate and a fixed plate,
the SMA wires are connected to the movable plate and the fixed plate, change respective lengths according to an input driving current to drive the movable plate to move relative to the fixed plate,
the sensor carrier is configured to move in accompany with the movable plate, and
the fixed plate is fixedly connected to the base.

24. The driving device according to claim 23, wherein the fixed plate is fixed on a surface of a rear side in the optical axis direction of the supporting substrate, and the sensor carrier is located on a rear side in the optical axis direction of the fixed plate.

25. The driving device according to claim 23, wherein the fixed plate is fixedly connected to the enclosure sidewall and the sensor carrier is located between the fixed plate and the supporting substrate.

26. The driving device according to claim 23, wherein the sensor carrier and the movable plate are integrally connected to each other or connected as two separate members.

27. A camera device comprising a lens, an image sensor, and a driving device according to any one of claim 1 for driving the lens to generate image data on the image sensor.

28. An electronic apparatus comprising a camera device according to claim 27.
